(19) United States
(12) Patent Application Publication
(10) Pub. No.: US 2018/0349791 A1
(43) Pub. Date: Dec. 6, 2018

(54) COMPANION LAUNCHER

(71) Applicant: TCL RESEARCH AMERICA INC., San Jose, CA (US)

(72) Inventor: Haohong WANG, San Jose, CA (US)

(21) Appl. No.: 15/610,217

(22) Filed: May 31, 2017

(51) Int. Cl. G06N 99/00; G06F 9/445; G06N 5/04; H04L 29/08; G06N 5/02

(52) U.S. Cl. CPC G06N 99/005; G06F 9/445; G06N 5/02; H04L 67/10; G06N 5/04

(57) ABSTRACT

A companion launcher comprises: a context-sensing module configured to sense context information and user behavior; a moment-recognition engine configured to recognize a moment based on the context information and user behavior, the moment indicating a timing that a user of a mobile device has a predicted need; a FUNN-recommending module configured to: mine a plurality of functional tools and/or services of one or more applications based on the moment, the plurality of functional tools and/or services of one or more applications being linked to the predicted need of the user, and recommend a FUNN to the user through a user interface of the mobile device, the FUNN including a plurality of function accessing points to the plurality of functional tools and/or services of one or more applications; and a user-interaction module configured to launch the FUNN on the mobile device in response to receiving a user confirmation to the recommendation.

### FIELD OF THE INVENTION

The present invention generally relates to the field of information technology and, more particularly, to a companion launcher.

### BACKGROUND

Applications (Apps) have become the primary means of user interaction on mobile devices such as smart phones, tablets, smart watches, and other wearable devices. The usage of Apps has rapidly increased recently. However, time spent with Apps in mobile devices is concentrated in a limited number of Apps. Compared with the number of total Apps in the world, the small percentage suggests that people are significantly underutilizing the broad offering of Apps available and hence the potential power of their mobile devices.

One reason for this limited Apps usage is the inability of the user to discover the unique power or capability of a given app. A related reason is the difficulty of even discovering that an App exists to meet a specific need. Even once apps are discovered and learned, leveraging their full capability presents another impediment. While some needs are small enough to be resolved by a single app, others require multiple apps, since each one typically presents a constrained and targeted view that fails to match the broad, complex and often changeable environment that the user may find himself/herself in at any given moment.

The disclosed companion launcher is directed to solve one or more problems set forth above and other problems.

### BRIEF SUMMARY OF THE DISCLOSURE

One aspect of the present disclosure includes a companion launching method, comprising: sensing, by a context-sensing module, context information and user behavior associated with a mobile device; recognizing, by a moment-recognition engine, a moment based on the context information and user behavior, the moment indicating a timing that a user of the mobile device has a predicted need; mining, by a FUNN-recommending module, a plurality of functional tools and/or services of one or more applications based on the moment, the plurality of functional tools and/or services of one or more applications being linked to the predicted need of the user; recommending, by the FUNN-recommending module, a FUNN to the user through a user interface of the mobile device, the FUNN including a plurality of function accessing points to the plurality of functional tools and/or services of one or more applications; and launching, by a user-interaction module, the FUNN on the mobile device in response to receiving a user confirmation to the recommendation.

In some embodiments, the context-sensing module includes: one or more hardware sensors inside the mobile device to obtain the context information, including at least one of time information, location information, activity information, connection information; and one or more software sensors to detect the user behavior.

In some embodiments, the method further comprises: determining a recommending value indicating a relevancy between the moment and each of the functional tools and/or services of one or more applications of the FUNN; and ranking the plurality of functional tools and/or services of one or more applications based on the recommending value.

In some embodiments, the method further comprises: recording, by the user-interaction module, user-interaction in response to the recommended FUNN; updating a personalization knowledge database based on the recorded user-interaction; and mining the plurality of functional tools and/or services of one or more applications based on the personalization knowledge database.

In some embodiments, the method further comprises: determining, by a hardware processer of the mobile device, whether the mobile device has a build-in dual launcher including an App-centric model launcher and a moment-first model launcher, wherein the moment-first model launcher includes the context-sensing module, the moment-recognition engine, the FUNN-recommending module, and the user-interaction module; and in response to determining that the mobile device does not include the moment-first launcher, presenting a promotion to install the moment-first model launcher.

In some embodiments, the method further comprises: preparing a personalization knowledge database for the moment-first model launcher by using the App-centric model launcher in the mobile device to learn user preferences in a time period.

In some embodiments, the method further comprises: downloading a personalization knowledge database for the moment-first model launcher from a cloud server.

In some embodiments, the method further comprises: presenting a promotion to install the moment-first model launcher on a second mobile device.

In some embodiments, the method further comprises: downloading a personalization knowledge database for the moment-first model launcher from the mobile device or from a cloud server to the second mobile device.

In some embodiments, the method further comprises: performing an on-board process to migrate user from the app-centric model launcher to the moment-first model launcher, the on-board process including at least one of: presenting teasers to attract a user to try out the moment-first model launcher; presenting instructions to help the user understand a difference between FUNN-based operations and App-based operations; presenting instructions to help the user understand a difference between the moment-first model launcher and the App-centric model launcher; presenting instructions to get the user started with a basic usage model of the moment-first model launcher by using a group of applications that the user uses daily; presenting instructions to get the user started with a basic usage model of the moment-first model launcher by using a hybrid of a group of FUNNs and the group of applications; and presenting instructions to get the user started with a basic usage model of the moment-first model launcher by using the group of FUNNs without applications involved.

Another aspect of the present disclosure provides a companion launcher, comprising: a context-sensing module configured to sense context information and user behavior associated with a mobile device; a moment-recognition engine configured to recognize a moment based on the context information and user behavior, the moment indicating a timing that a user of the mobile device has a predicted need; a FUNN-recommending module configured to: mine a plurality of functional tools and/or services of one or more applications based on the moment, the plurality of functional tools and/or services of one or more applications being linked to the predicted need of the user, and recommend a FUNN to the user through a user interface of the mobile device, the FUNN including a plurality of function accessing points to the plurality of functional tools and/or services of one or more applications; and a user-interaction module configured to launch the FUNN on the mobile device in response to receiving a user confirmation to the recommendation.

In some embodiments, the context-sensing module includes: one or more hardware sensors inside the mobile device to obtain the context information, including at least one of time information, location information, activity information, connection information; and one or more software sensors to detect the user behavior.

In some embodiments, the FUNN-recommending module is further configured to: determine a recommending value indicating a relevancy between the moment and each of the functional tools and/or services of one or more applications of the FUNN; and rank the plurality of functional tools and/or services of one or more applications based on the recommending value.

In some embodiments, the user-interaction module is further configured to: record user-interaction in response to the recommended FUNN; update a personalization knowledge database based on the recorded user-interaction; and mine the plurality of functional tools and/or services of one or more applications based on the personalization knowledge database.

In some embodiments, the mobile device includes a hardware processer configured to: determine whether the mobile device has a build-in dual launcher including an App-centric model launcher and a moment-first model launcher, wherein the moment-first model launcher includes the context-sensing module, the moment-recognition engine, the FUNN-recommending module, and the user-interaction module; and in response to determining that the mobile device does not include the moment-first launcher, cause the mobile device to present a promotion to install the moment-first model launcher.

In some embodiments, the hardware processer is further configured to: prepare a personalization knowledge database for the moment-first launcher by using the App-centric model launcher in the mobile device to learn user preferences in a time period.

In some embodiments, the hardware processer is further configured to: download a personalization knowledge database for the moment-first model launcher from a cloud server.

In some embodiments, the hardware processer is further configured to: present a promotion to install the moment-first model launcher on a second mobile device.

In some embodiments, the second mobile device includes a second hardware processer configured to download a personalization knowledge database for the moment-first model launcher from the mobile device or from a cloud server to the second mobile device.

In some embodiments, the second hardware processer is further configured to; perform an on-board process to migrate user from the app-centric model launcher to the moment-first model launcher, the on-board process including at least one of: presenting teasers to attract a user to try out the moment-first model launcher; presenting instructions to help the user understand a difference between FUNN-based operations and App-based operations; presenting instructions to help the user understand a difference between the moment-first model launcher and the App-centric model launcher; presenting instructions to get the user started with a basic usage model of the moment-first model launcher by using a group of applications that the user uses daily; presenting instructions to get the user started with a basic usage model of the moment-first model launcher by using a hybrid of a group of FUNNs and the group of applications; and presenting instructions to get the user started with a basic usage model of the moment-first model launcher by using the group of FUNNs without applications involved.

Other aspects of the present disclosure can be understood by those skilled in the art in light of the description, the claims, and the drawings of the present disclosure.

### BRIEF DESCRIPTION OF THE DRAWINGS

FIG. 1 illustrates a schematic diagram of an exemplary environment in accordance with some embodiments of the present disclosure;

FIG. 2 illustrates a schematic block diagram of an exemplary computing system in accordance with some embodiments of the present disclosure;

FIG. 3 illustrates a schematic structural diagram of an exemplary moment-first model launcher on a mobile device in accordance with some embodiments of the present disclosure;

FIG. 4 illustrates a schematic flowchart of an exemplary process for recommending and launching FUNNs by the moment-first model launcher in accordance with some embodiments of the present disclosure;

FIGS. 5A, 5B and 5C illustrate schematic diagrams of exemplary user-interfaces of a mobile device representing a flow of moments in accordance with some embodiments of the present disclosure;

FIG. 6 illustrates a schematic structural diagram of an exemplary a companion launcher (CL) framework on mobile devices in accordance with some embodiments of the present disclosure; and

FIG. 7 illustrates a schematic flowchart of an exemplary method for applying companion launcher (CL) framework on mobile devices is illustrated in accordance with some embodiments of the present disclosure.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

In accordance with some embodiments of the present disclosure, a companion launcher is provided. Specifically, the disclosed companion launcher enables disruptive user experience revolution from app-centric model to moment-first model. An app-centric model requires the user to find one or more Apps to achieve his (or her) desired needs, while a moment-first model only requires the user to make decisions based on the services recommended by the disclosed method and systems, as the disclosed companion launcher can take care of the part of sensing/recognizing the current moment and then recommending function tools or services provided by one or more Apps for potential tasks associated with the current moment.

In some embodiments, a dual-launcher framework is applied to achieve such migration of the mobile user experience to the moment-first model. In the dual-launcher framework (e.g., containing a moment-first model launcher and an App-centric model launcher), a moment-task-decision structure is used to reorganize the mobile user interface and interactional models to follow a moment flow with dynamically recommended FUNNs fitting into the recognized current moment.

In some embodiments, FUNN represents a subset of App “intelligence” that addresses particular user needs. For example, FUNN can include a plurality of function accessing points to functions in Apps or connected services, such as shortcuts to a page of a native mobile App, entrances to web App functions, customized functions on mobile devices based on cloud (application programming interfaces) API services, etc.

For example, a FUNN can include various functional tools of one or more Apps, such as photo-processing tools, speech recognition and language understanding tools, and so on. As another example, a FUNN can also include various services in a specific field provided by one or more Apps, such as live TV channels, coffee order services, parking reservation services, map and navigation services, etc.

By utilizing one or more FUNNs, a user can achieve his/her desired goal with a continuous function flow, instead of switching among multiple apps. In the disclosed moment-first model, the leverage of machine learning and data mining can bridge a user's needs across App boundaries, matching context, and knowledge of the user with desire services and interaction models between the user and the mobile device.

The disclosed companion launcher framework has a dual-launcher structure containing a moment-first model launcher for one or more mobile devices. In some embodiments, the moment-first model launcher can be a secondary companion of a mobile device's main launcher using the App-centric model. In some alternative embodiments, the moment-first model launcher can also be the main launcher of a mobile device, as long as the personalization knowledge database is available.

The moment-first model launcher has a moment-task-decision structure to automatically recognize a moment flow of a user, and predict the user's possible needs with desired tasks or services. The user experience (UX) flow is driven by the moment flow and the recommended FUNNs dynamically.

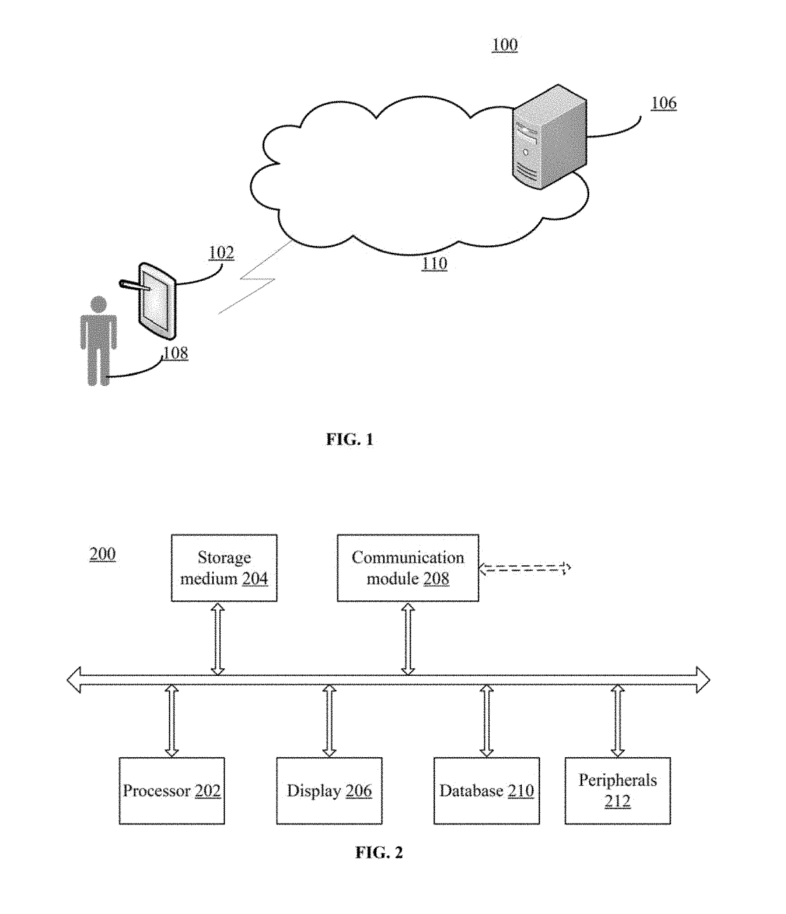

FIG. 1 illustrates a schematic diagram of an exemplary environment 100 in accordance with some embodiments of the present disclosure. As shown in FIG. 1, environment 100 may include one or more terminals 102, one or more servers 106, a user 108, and a network 110.

A terminal 102 (also known as a terminal device) may refer to any appropriate user terminal with certain computing capabilities, such as a personal computer (PC), a work station computer, a server computer, a hand-held computing device (tablet), a smart phone or mobile phone, a smart watch or any other user-side computing device. In certain embodiments, a terminal 102 may be a mobile device, such as a smart phone, a tablet computer, or a mobile watch, etc. The mobile device may be implemented on any appropriate computing platform.

The terminal 102 may be used by any user 108 to connect to network 110 and make requests to server 106. Each user 102 may use one or more terminals 102. As directed by the user 108, the terminal 102 may include a plurality of applications (Apps) or be able to access to plurality of applications (Apps) from any appropriate sources, such as from a local storage device, from a wired or wireless network device of service providers, or from the Internet.

Further, the server 106 may refer to one or more server computers configured to provide certain functionalities, such as cloud storage services, information query services, application downloading services, etc. The server 106 may include one or more processors to execute computer programs in parallel. The server 106 may store various applications to be accessed by terminals. The server 106 may also be a cloud server.

Terminals 102 and server 106 may communicate with each other through communication network 110, such as a cable network, a phone network, and/or a satellite network, etc. Although one user 108, one terminal 102, and one server 106 are shown in FIG. 1, any number of users, terminals, and/or servers may be included.

Terminal 102, and/or server 106 may be implemented on any appropriate computing circuitry platform. FIG. 2 shows a schematic block diagram of an exemplary computing system 200 capable of implementing terminal 102, and/or server 106.

As shown in FIG. 2, computing system 200 may include a processor 202, a storage medium 204, a display 206, a communication module 208, a database 210, and peripherals 212. Certain devices may be omitted and other devices may be included.

Processor 202 may include any appropriate hardware processor or processors. Further, processor 202 can include multiple cores for multi-thread or parallel processing. Storage medium 204 may include memory modules, such as ROM, RAM, flash memory modules, and mass storages, such as CD-ROM and hard disk, etc. Storage medium 204 may store computer programs for implementing various processes, when the computer programs are executed by processor 202.

Further, peripherals 212 may include various sensors and other I/O devices, such as keyboard, mouse, touch screen, etc. Communication module 208 may include certain network interface devices for establishing connections through communication networks. Database 210 may include one or more databases for storing certain data and for performing certain operations on the stored data, such as database searching.

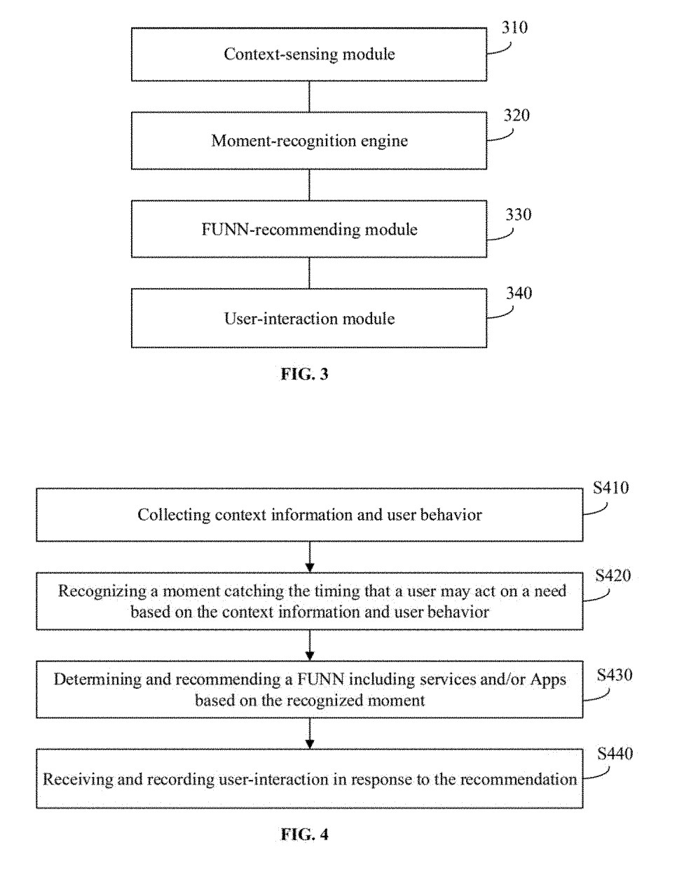

Referring to FIG. 3, a schematic architecture of an exemplary moment-first model launcher is illustrated in accordance with some embodiments of the present disclosure. FIG. 4 shows a schematic flowchart of an exemplary process for recommending and launching FUNNs by the moment-first model launcher in accordance with some embodiments of the present disclosure.

The mobile user experience can include a series of moments that are intent-rich moments corresponding to desire statements, such as I-want-to-know, I-want-to-go, I-want-to-do, I-want-to-buy, etc. In such moments, decisions are made and preferences are shaped in association with a range of contexts, such as sitting in front of the TV, in the car, in a meeting, etc. The context of such moments can be perceived by mobile sensors and/or algorithms, which recognize these moments automatically or semi-automatically.

Given the close relationship between contextualized moments and user intention, a moment-first model can be built in the mobile devices to fit better into users' natural behavior model. In contrast to the app-centric mobile user experience, in which a user has to select, search for, and/or discover one or more Apps from a wide variety of options, FUNN-enabled moment-first model can better cater to a moment-first user experience. As such, a user can directly access a FUNN that fulfills his/her immediate needs in the current moment in a contextually appropriate way.

The high-level architecture of moment-first model launcher is illustrated in FIG. 3. The moment-first model launcher can include a context-sensing module 310, a moment-recognition engine 320, a FUNN-recommending module 330, and a user-interaction module 340.

In some embodiments, the context-sensing module 310 can include one or more hardware sensors and/or software sensors for collecting context information and user behavior at S410. The hardware sensors can be built inside a mobile device, such as GPS, accelerometer, gyroscope, Bluetooth, and so on to obtain the context information, including time information, location information, activity information, connection information, etc. The software sensors can be built inside services and/or Apps to detect the user behavior or information user concerns, such as a photo posting on a social media network, a pre-scheduled event, a warning indicating that a stock price reached a threshold, and so on.

In some embodiments, the context category can be determined by the mobile device based on the context information and user behavior, while some part of the context category may require certain partnership between the mobile device and the service providers and/or App developers.

The moment-recognition engine 320 can be used to recognize a moment catching the timing that a user may act on a need based on the context information and user behavior at S420. In some embodiments, the moment can be recognized by sensing, incoming events, user requirement, etc. By using the context category and known attributes of a user's behavior, user intents can be analyzed, and potential services and/or Apps associated with the user intents can be mined.

For example, when the mobile device detects a workplace WiFi access point SSID, the processed sensing data may indicate the user is currently in a workplace, and the user intent may include opening unread work-related emails. As another example, when the home WiFi access point SSID is detected, it can indicate that the user is at home, and the user intent may include opening family entertainment media system.

The FUNN-recommending module 330 can determine and recommend a FUNN including services and/or Apps based on the recognized moment at S430. The user intention, determined and shaped by the context of the current moment, allows for personalized FUNN recommendations to be triggered, linking the user directly to the available services and/or Apps that can fulfill his/her current need. The better the understanding of the user intention, the better the services/Apps recommendation and thus the better the user experience achieved.

For example, the FUNN-recommending module 330 can prompt a message including a list of services/Apps to the user at S430. In some embodiments, the services/Apps can be ranked based on a recommending value indicating a relevancy between the recognized moment and corresponding services/Apps.

It should be noted that, any suitable techniques and/or algorithms can be applied in the areas of moment sensing, detection and recognition, services/Apps mining, user intention discovery and understanding, and personalized FUNN recommendations described above. For example, the potential solutions and example implementations addressed in “A Mobile World made of Functions, H. Wang, APSIPA Trans. Signal & Information Processing. Vol. 6, 2017.” can be used to perform steps S410, S420 and S430. The entirety of the reference “A Mobile World made of Functions, H. Wang, APSIPA Trans. Signal & Information Processing. Vol. 6, 2017.” is incorporated herein.

The user-interaction module 340 can receive and record user-interaction in response to the prompted message at S440. Based on the received user-interaction, a FUNN including one or more recesses to the selected services/Apps can be performed. As such, a certain user experience specifically designed for the current moment can be realized. Further. the user-interaction can be recorded into a personalization knowledge database stored either on the mobile device or on the cloud or on both. The personalization knowledge database can be updated regularly by mining the user behavior data reported from the user-interaction module 340.

In some embodiments, the user-interaction can be recorded and counted. The average user-interaction count (e.g., number of touches or gestures on a mobile device) can be used as a measure of user-experience success on the mobile device. A lower average user-interaction count may indicate a better user experience. In other words, if the user behavior and preferences have been learned and the system is able to predict the user's next immediate need and thus can prepare the appropriate FUNN to satisfy such need, then the user experience is optimized.

Further, the moment-first model launcher can apply the entire process illustrated in FIG. 4 repeatedly to detecting a flow of moments, and recommend and launch corresponding FUNNs based on the flow of moments.

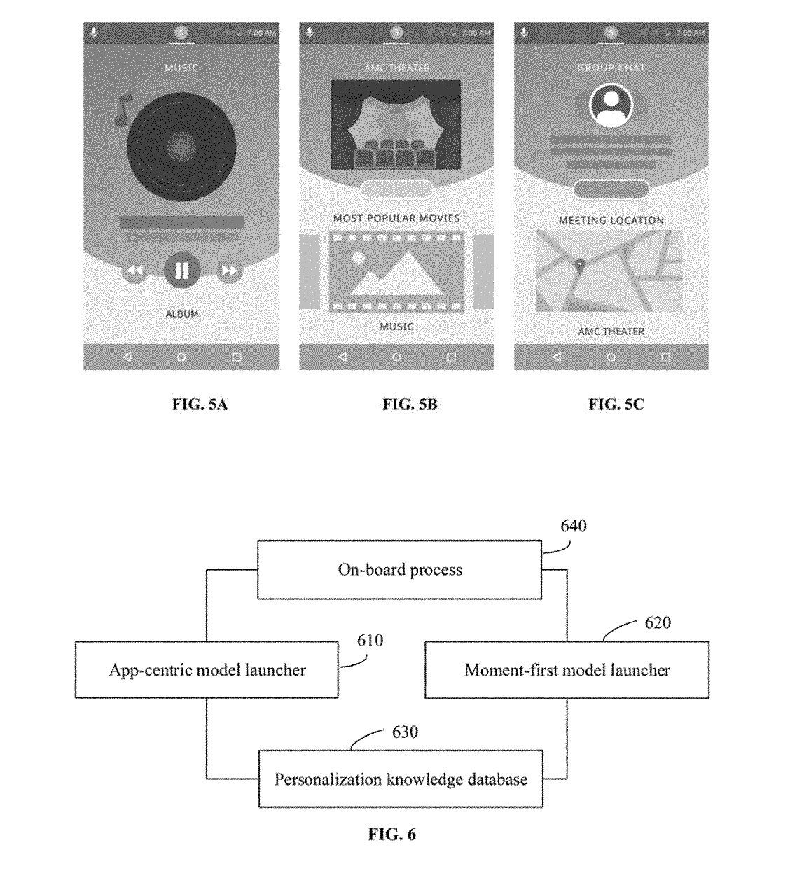

Referring to FIG. 5, schematic diagrams of exemplary user-interface of a mobile device representing a flow of moments are shown consistent with some embodiments of the present disclosure. As shown in FIG. 5A, a user action of making an order of playing music is detected on a mobile device, so the moment-first model launcher on the mobile device can enter the first moment of music playback. As shown in FIG. 5B, when it is detected that the user walked passing a theater, the mobile device can sense this new potential moment, once user decided to pick up this new moment, the moment-first model launcher can enter the second moment to present the popular movies that are currently shown in the theater. Then, as shown in FIG. 5C, an incoming meeting invitation comes in with notification appears on the screen of the mobile device, once the user accepted, the moment-first model launcher can start the meeting moment with associated tasks such as group chat, meeting location and schedule arrangement.

In some embodiments, at the timing the user turns on his (or her) mobile device screen, the current moment recognized by the moment-first model launcher can be displayed with a predicted FUNN that represent the associated services/Apps for the current moment.

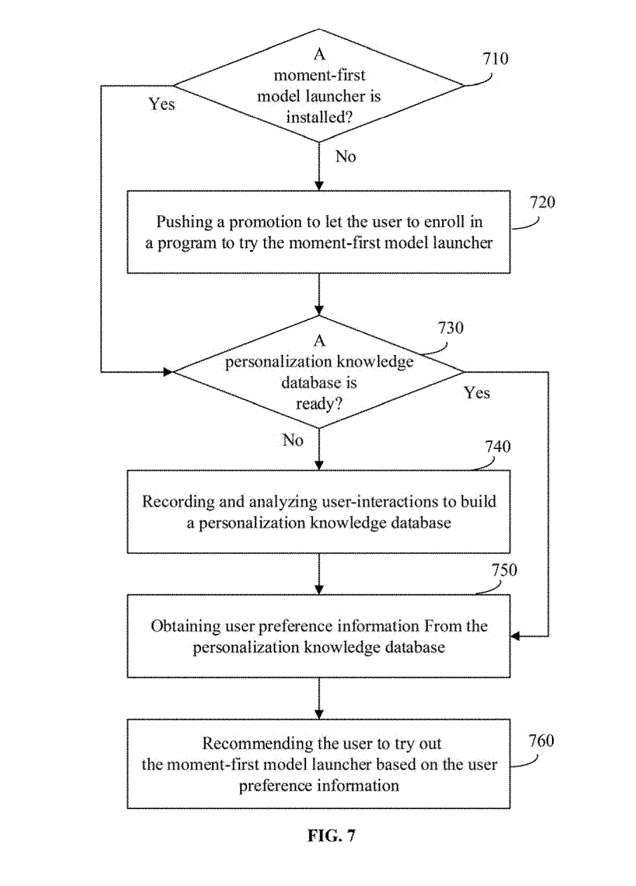

Referring to FIG. 6, a schematic structural diagram of an exemplary a companion launcher (CL) framework on mobile devices is shown in accordance with some embodiments of the present disclosure. As illustrated, the companion launcher (CL) framework can include an App-centric model launcher 610, a moment-first model launcher 620, a personalization knowledge database 630, and an on-board process 640.

The App-centric model launcher 610 can be any existing mechanism to launch Apps in a mobile device. That is, a user has to pull information out of the mobile device by first look for desired Apps in the menu shown on screen or via voice interface. In some embodiments, the App-centric model launcher 610 can be used to record user's daily operations for providing user behavior knowledge. The moment-first model launcher 620 can be referred to the above descriptions in connection with FIGS. 3-4. The App-centric model launcher(s) 610 and the moment-first model launcher(s) 620 can be configured in a same mobile device or in two or more different mobile devices respectively.

The personalization knowledge database 630 can include user behavior knowledge learned from the user's daily operations on the app-centric model launcher 610 and moment-first model launcher 620. The user behavior knowledge can include any suitable information related to the user of the mobile device, such as user preferences to services/Apps, user-interaction records in response to FUNN recommendations, etc.

It should be noted that, the personalization knowledge database 630 can be stored in a local mobile device or on cloud. For example, when the App-centric model launcher 610 and the moment-first model launcher 620 are configured in a same mobile device, the personalization knowledge database 630 can be stored in such mobile device. As another example, when there are multiple App-centric model launchers 610 and moment-first model launchers 620 that are configured in a plurality of mobile devices respectively, the personalization knowledge database 630 can be stored on cloud and be shared by the multiple App-centric model launchers 610 and moment-first model launchers 620 of the plurality of mobile devices.

The on-board process 640 can provide a smooth process to migrate user from the app-centric model launcher 610 to the moment-first model launcher 620. Since user behavior of the device may change from the app-centric model launcher 610 to the moment-first model launcher 620, the on-board process 640 can be used to help a user to get comfortable to the transition. In some embodiments, the on-board process 640 may include at least one of the following components:

(1) Teasers to attract user to try out the moment-first model launcher 620;

(2) Instructions to help user understand the difference between FUNN-based operations and App-based operations;

(3) Instructions to help user understand the difference of moment-first model compared to the App-centric model;

(4) Instructions to get user started with a basic usage model of the moment-first model launcher 620 by using a group of Apps that the user uses daily to achieve the moment-first experience;

(5) Instructions to get user started with a basic usage model of the moment-first model launcher 620 by using a hybrid of FUNNs and Apps to achieve the moment-first experience;

(6) Instructions to get user started with a basic usage model of the moment-first model launcher 620 by using a group of FUNNs (and could be no Apps involved) to achieve the moment-first experience.

Referring to FIG. 7, a schematic flowchart of an exemplary method for applying companion launcher (CL) framework on mobile devices is illustrated in accordance with some embodiments of the present disclosure.

At step S710, it can be determined that whether a moment-first model launcher is installed.

In response to determining that a moment-first model launcher is not installed in a first mobile device (“No” at S710), the first mobile device may push a promotion to let the user to enroll in a program to try the moment-first model launcher at S720.

In some embodiments, the moment-first model launcher can be downloaded and installed to the first mobile device. If the first mobile device has an App-centric model launcher installed before, the App-centric model launcher and the moment-first model launcher can form a dual launcher structure, in which the primary launcher follows the App-centric model, and the secondary launcher follows the moment-first model.

In some other embodiments, the moment-first model launcher can be downloaded and installed to a second mobile device associated with the first mobile device. The moment-first model launcher can be used as the primary launcher of the second mobile device. That is, the dual-launcher structure may not require that the App-centric model launcher and a moment-first model launcher to be installed in a same mobile device. The App-centric model launcher and the moment-first model launcher can be realized either on the same mobile device, or on different mobile devices.

In response to determining that a moment-first model launcher has been already installed (“Yes” at S710), or after the moment-first model launcher being installed at S720, it can be determined that whether a personalization knowledge database is ready to be accessed for obtaining user preference information for the moment-first model launcher at S730.

In some embodiments, if there is no existing personalization knowledge database (“No” at S730), the user-interactions can be recorded and analyzed to build the personalization knowledge database at S740.

For example, the App-centric model launcher and/or the moment-first launcher can record and analyze user-interactions, learn the user preferences, and prepare the personalization knowledge database in a certain period of time, such as two to four weeks.

As another example, when a user has multiple mobile devices, the App-centric model launchers installed in the multiple mobile devices can record user-interactions performed on each App-centric model launcher. As such, the recorded user-interaction histories during a certain period of time can be uploaded from the multiple mobile devices, the user preferences can be leaned by analyzing the combined information, and the personalization knowledge database can be established based on the user preferences.

Note that, the personalization knowledge database can be stored either locally or remotely. For example, when both of the App-centric model launcher and the moment-first launcher are installed in the first mobile device, the personalization knowledge database can be stored either in the first mobile device or on cloud. As another example, when the App-centric model launcher and the moment-first launcher are installed in two or more different mobile devices respectively, the personalization knowledge database can be stored on cloud and shared by the two or more different mobile devices.

In some other embodiments, if a personalization knowledge database is ready (“Yes” at S730), or after the personalization knowledge database being built at S740, the personalization knowledge database can be accessed for obtaining user preference information for the moment-first model launcher at S750.

In some embodiments, when the personalization knowledge database is stored in the local mobile device, the personalization knowledge database can be directly accessed to obtain the user preference information. In some other embodiments, when the personalization knowledge database is stored on cloud, the personalization knowledge database can be downloaded or be accessed online to obtain the user preference information.

In some alternative embodiments, the personalization knowledge database can be transferred from one mobile device to another mobile device. For example, when it is known that the personalization knowledge database is stored associated with the App-centric model launcher in the first mobile device, and the moment-first model launcher is downloaded and installed to the second mobile device associated with the first mobile device, the personalization knowledge database can be transferred directly from the first mobile device to the second mobile device. As such, the moment-first model launcher installed in the second mobile device can access the personalization knowledge database to obtain the user preference information.

Once the user preference information can be obtained from the personalization knowledge database, the on-boarding process of the companion launcher can start to recommend the user to try out the moment-first model launcher at S760. Since some people may like the moment-first model launcher, and others may want to go back to the App-centric model launcher that they are already familiar with. The companion launcher can allow the user to return to App-centric model launcher as long as they want.

It should be noted that, the above steps of the flow diagrams of FIGS. 4 and 7 can be executed or performed in any order or sequence not limited to the order and sequence shown and described in the figures. Also, some of the above steps of the flow diagrams of FIGS. 4 and 7 can be executed or performed substantially simultaneously where appropriate or in parallel to reduce latency and processing times. Furthermore, it should be noted that FIGS. 4 and 7 are provided as an example only. At least some of the steps shown in the figures may be performed in a different order than represented, performed concurrently, or altogether omitted.

In addition, the flowcharts and block diagrams in the figures illustrate various embodiments of the disclosed method and system, as well as architectures, functions and operations that can be implemented by a computer program product. In this case, each block of the flowcharts or block diagrams may represent a module, a code segment, a portion of program code. Each module, each code segment, and each portion of program code can include one or more executable instructions for implementing predetermined logical functions.

It should also be noted that, in some alternative implementations, the functions illustrated in the blocks be executed or performed in any order or sequence not limited to the order and sequence shown and described in the figures. For example, two consecutive blocks may actually be executed substantially simultaneously where appropriate or in parallel to reduce latency and processing times, or even be executed in a reverse order depending on the functionality involved in.

It should also be noted that, each block in the block diagrams and/or flowcharts, as well as the combinations of the blocks in the block diagrams and/or flowcharts, can be realized by a dedicated hardware-based system for executing specific functions, or can be realized by a dedicated system combined by hardware and computer instructions.

The disclosed subject matter provides a computer program product that includes computer-readable storage medium storing program codes. The program code includes instructions for performing the disclosed method. The specific implementations of the disclosed method can be referred to the various embodiments described above in connection with FIGS. 1-4.

Those skilled in the art can clearly understand that, for convenience and simplicity of description, the specific working process of the systems, modules and units described above can be referred to the corresponding processes of various embodiments of the disclosed method described above.

In various embodiments provided herein, it should be understood that, the disclosed system and method can be realized through other ways. The disclosed embodiments of the system are merely illustrative. For example, the divisions of modules and units are merely divisions of logical functions which may be divided by other ways in the actual implementation. As another example, multiple units or modules can be combined or be integrated into another system. Some features can be ignored, or not be executed. At another point, the illustrated or discussed mutual coupling, direct coupling, or communicating connection can be coupled or connected through electrical, mechanical, or other type of communication interfaces.

A module/unit described as a separate member may be or may not be physically separated. A component illustrated as a module/unit may be or may not be a physical module/unit. A module/unit can be located in one place, or be distributed to multiple network elements. According to actual needs, a part of or all of the modules/units can be selected to realize the purpose of disclosed subject matter.

Further, various functional modules/units in the various embodiments of the disclosed subject matter can be integrated in a processing module/unit, or can be separate physical modules/units. Two or more functional modules/units can also be integrated in one module/unit.

If the functions are implemented as software functional modules/units, and being used or sold as a standalone product, the product can be stored in a computer readable storage medium. Based on this understanding, an essential part of the technical nature of the disclosed subject matter, or a part of the technical nature of the disclosed subject matter that can contribute to prior arts, or any part of the technical nature of the disclosed subject matter, can be embodied in a form of a computer software product. The computer software product can be stored in a storage medium, including multiple instructions to instruct a computer device (may be a personal computer, a server, or a network equipment) to perform all or part of the steps of the disclosed method according to various embodiments. The aforementioned storage media can include: U disk, removable hard disk, read only memory (ROM), random access memory (RAM), floppy disk, CD-ROM, or any other suitable medium that can store program codes.

Accordingly, methods for recommending and launching applications on mobile devices and systems thereof are provided.

The disclosed methods and systems for recommending and launching applications on mobile devices include a moment-first model launcher. It is a radical user experience change from the App-centric model to the moment-first model. The App-centric model requires the user to find one or more Apps to achieve his (or her) desired needs, while the moment-first model only requires the user to make decisions based on the services recommended by the disclosed method and systems, as the disclosed methods and systems can take care of the part of sensing/recognizing the current moment and then recommending FUNNs for potential tasks associated with the current moment.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

What is claimed is:

1. A companion launching method, comprising:
sensing, by a context-sensing module, context information and user behavior associated with a mobile device;
recognizing, by a moment-recognition engine, a moment based on the context information and user behavior, the moment indicating a timing that a user of the mobile device has a predicted need;
mining, by a FUNN-recommending module, a plurality of functional tools and/or services of one or more applications based on the moment, the plurality of functional tools and/or services of one or more applications being linked to the predicted need of the user;
recommending, by the FUNN-recommending module, a FUNN to the user through a user interface of the mobile device, the FUNN including a plurality of function accessing points to the plurality of functional tools and/or services of one or more applications; and
launching, by a user-interaction module, the FUNN on the mobile device in response to receiving a user confirmation to the recommendation.

2. The method of claim 1, wherein the context-sensing module includes:
one or more hardware sensors inside the mobile device to obtain the context information, including at least one of time information, location information, activity information, connection information; and
one or more software sensors to detect the user behavior.

3. The method of claim 1, further comprising:
determining a recommending value indicating a relevancy between the moment and each of the functional tools and/or services of one or more applications of the FUNN; and
ranking the plurality of functional tools and/or services of one or more applications based on the recommending value.

4. The method of claim 1, further comprising:
recording, by the user-interaction module, user-interaction in response to the recommended FUNN;
updating a personalization knowledge database based on the recorded user-interaction; and
mining the plurality of functional tools and/or services of one or more applications based on the personalization knowledge database.

5. The method of claim 1, further comprising:
determining, by a hardware processer of the mobile device, whether the mobile device has a build-in dual launcher including an App-centric model launcher and a moment-first model launcher, wherein the moment-first model launcher includes the context-sensing module, the moment-recognition engine, the FUNN-recommending module, and the user-interaction module; and
in response to determining that the mobile device does not include the moment-first launcher, presenting a promotion to install the moment-first model launcher.

6. The method of claim 5, further comprising:
preparing a personalization knowledge database for the moment-first model launcher by using the App-centric model launcher in the mobile device to learn user preferences in a time period.

7. The method of claim 5, further comprising:
downloading a personalization knowledge database for the moment-first model launcher from a cloud server.

8. The method of claim 5, further comprising:
presenting a promotion to install the moment-first model launcher on a second mobile device.

9. The method of claim 8, further comprising:
downloading a personalization knowledge database for the moment-first model launcher from the mobile device or from a cloud server to the second mobile device.

10. The method of claim 5, further comprising:
performing an on-board process to migrate user from the app-centric model launcher to the moment-first model launcher, the on-board process including at least one of:
presenting teasers to attract a user to try out the moment-first model launcher;
presenting instructions to help the user understand a difference between FUNN-based operations and App-based operations;
presenting instructions to help the user understand a difference between the moment-first model launcher and the App-centric model launcher;
presenting instructions to get the user started with a basic usage model of the moment-first model launcher by using a group of applications that the user uses daily;
presenting instructions to get the user started with a basic usage model of the moment-first model launcher by using a hybrid of a group of FUNNs and the group of applications; and
presenting instructions to get the user started with a basic usage model of the moment-first model launcher by using the group of FUNNs without applications involved.

11. A companion launcher, comprising:
a context-sensing module configured to sense context information and user behavior associated with a mobile device;
a moment-recognition engine configured to recognize a moment based on the context information and user behavior, the moment indicating a timing that a user of the mobile device has a predicted need;
a FUNN-recommending module configured to:
mine a plurality of functional tools and/or services of one or more applications based on the moment, the plurality of functional tools and/or services of one or more applications being linked to the predicted need of the user, and
recommend a FUNN to the user through a user interface of the mobile device, the FUNN including a plurality of function accessing points to the plurality of functional tools and/or services of one or more applications; and
a user-interaction module configured to launch the FUNN on the mobile device in response to receiving a user confirmation to the recommendation.

12. The companion launcher of claim 11, wherein the context-sensing module includes:
one or more hardware sensors inside the mobile device to obtain the context information, including at least one of time information, location information, activity information, connection information; and
one or more software sensors to detect the user behavior.

13. The companion launcher of claim 11, wherein the FUNN-recommending module is further configured to:
determine a recommending value indicating a relevancy between the moment and each of the functional tools and/or services of one or more applications of the FUNN; and
rank the plurality of functional tools and/or services of one or more applications based on the recommending value.

14. The companion launcher of claim 11, wherein the user-interaction module is further configured to:
record user-interaction in response to the recommended FUNN;
update a personalization knowledge database based on the recorded user-interaction; and
mine the plurality of functional tools and/or services of one or more applications based on the personalization knowledge database.

15. The companion launcher of claim 11, wherein the mobile device includes:
a hardware processer configured to:
determine whether the mobile device has a build-in dual launcher including an App-centric model launcher and a moment-first model launcher, wherein the moment-first model launcher includes the context-sensing module, the moment-recognition engine, the FUNN-recommending module, and the user-interaction module; and
in response to determining that the mobile device does not include the moment-first launcher, cause the mobile device to present a promotion to install the moment-first model launcher.

16. The companion launcher of claim 15, wherein the hardware processer is further configured to:
prepare a personalization knowledge database for the moment-first launcher by using the App-centric model launcher in the mobile device to learn user preferences in a time period.

17. The companion launcher of claim 15, wherein the hardware processer is further configured to:
download a personalization knowledge database for the moment-first model launcher from a cloud server.

18. The companion launcher of claim 15, wherein the hardware processer is further configured to:
present a promotion to install the moment-first model launcher on a second mobile device.

19. The companion launcher of claim 18, wherein:
the second mobile device includes a second hardware processer configured to download a personalization knowledge database for the moment-first model launcher from the mobile device or from a cloud server to the second mobile device.

20. The companion launcher of claim 19, wherein the second hardware processer is further configured to:
perform an on-board process to migrate user from the app-centric model launcher to the moment-first model launcher, the on-board process including at least one of:
presenting teasers to attract a user to try out the moment-first model launcher;
presenting instructions to help the user understand a difference between FUNN-based operations and App-based operations;
presenting instructions to help the user understand a difference between the moment-first model launcher and the App-centric model launcher;
presenting instructions to get the user started with a basic usage model of the moment-first model launcher by using a group of applications that the user uses daily;
presenting instructions to get the user started with a basic usage model of the moment-first model launcher by using a hybrid of a group of FUNNs and the group of applications; and
presenting instructions to get the user started with a basic usage model of the moment-first model launcher by using the group of FUNNs without applications involved.
